(19) United States
(12) Patent Application Publication
(10) Pub. No.: US 2008/0313351 A1
(43) Pub. Date: Dec. 18, 2008

(54) DEVICE FOR MANAGING THE RECEIPT BY TERMINALS OF MULTIMEDIA CONTENT TRANSMITTED BY INFRASTRUCTURES THAT IMPLEMENT DIFFERENT TRANSMISSION TECHNIQUES

(75) Inventor: Bahman MOBASSER, Maurepas (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/129,357

(22) Filed: May 29, 2008

(30) Foreign Application Priority Data
Jun. 14, 2007 (FR) 0755750

(51) Int. Cl. G06F 15/16

(52) U.S. Cl. 709/241

(57) ABSTRACT

A device (D) Is dedicated to managing the receipt of multimedia content, originating from at least two multimedia content transmission infrastructures (TI1-TI5) implementing different transmission techniques, by at least one communication terminal (T) capable of connecting to at least two of these infrastructures. This device (D) comprises management means (MG) tasked, when one of the infrastructures (TI1-TI5) wants to transmit a piece of multimedia content to the communication terminal (T), with dynamically selecting, after consulting said terminal and the infrastructures (TI1-TI5) to which said terminal is connected and depending on the type of communication terminal (T) and the technical and/or commercial parameters chosen, the best transmission technique to use to transmit to the multimedia content, then with requesting that the communication terminal (T) configure its receiving means (SRM) so that it is capable of receiving the multimedia content to be transmitted via the infrastructure that implements the best transmission technique.

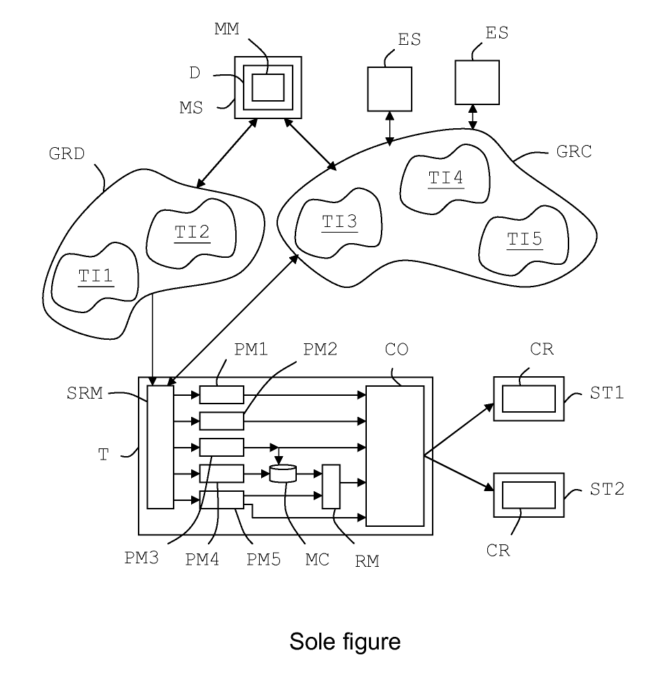

The invention pertains to multimedia content transmission infrastructures, and more precisely the transmission by such infrastructures of multimedia content to communication terminals.

Here, the term “multimedia content” refers to a set of data of the same type, such as television or radio programs, data files, audio files, or videos.

Furthermore, the term “multimedia content transmission infrastructure” here refers to both communication networks and distribution networks.

Additionally, the term “distribution network” here refers to any type of terrestrial and/or satellite distribution infrastructure capable of transmitting multimedia content along a downlink unidirectional channel to communication terminals.

Furthermore, the term “communication network” here refers to a type of bidirectional, broadband, wired or wireless communication infrastructure, in particular capable of distributing multimedia content to terminals, in broadcast, multicast, and/or unicast mode. Consequently, it may be a fixed-line network, such as XDSL or one using fiber or cables; a T-DMB network; a satellite network, such as an SDMB network (for “Satellite Digital Multimedia Broadcast”) or S-UMTS or SDR (“Satellite Digital Radio”); a terrestrial network that may be a radio network such as with a UMTS network capable of broadcasting (such as MBMS (for “Multimedia Broadcast/Multicast Services”) or its advanced version known as LTE (“Long Term Evolution”); or a DVB-H network (for “Digital Video Broadcasting—Handhelds”—mobile television); or a terrestrial network implementing a technology drawn from satellite technology (such as DVB-S, DVB-S2 or DVB-RCS); or a hybrid network, i.e. one that is both satellite and terrestrial, such as a DVB-SH network (satellite links with terrestrial relays).

Finally, the term “communication terminal” here refers to any fixed or mobile (or portable or cellular) communication device capable at least of receiving multimedia content from a multimedia content transmission structure (potentially by radio waves). Consequently, it may, for example, be a land-line or mobile (or cellular) telephone; a desktop or laptop computer; a personal digital assistant (or PDA); a multimedia content receiver (such as a decoder, residential gateway, or an STB (Set-Top Box)), so long as it is equipped with communication means, potentially by radio or satellite, capable of receiving multimedia content.

Multimedia content providers may use multiple transmission techniques implemented by different (multimedia content transmission) infrastructures to transmit multimedia content to users' (fixed or mobile) terminals. Among these different techniques, one may in particular cite distribution in streaming mode, in public over-the-air broadcast mode, in service provider over-the-air relay mode, in push-VoD mode, and in P2P client-to-client relaying mode.

Unfortunately, as is known to a person skilled in the art, none of these techniques may be considered “universally” optimal, no matter what type of multimedia content is being transmitted. This arises from the fact that numerous restrictions may occur in choosing a transmission technique (such as the bandwidth available at a given moment, the transmission frequencies available at a given moment, the type of multimedia content to be transmitted, the type of terminals that will receive multimedia content, and the cost for transmitting the multimedia content to be transmitted), and it is rare for one single transmission technique to be able to meet all of the restrictions in place at a given moment.

Certain multimedia content providers use two (multimedia content transmission) infrastructures that implement two different transmission techniques to transmit their multimedia content to their customers. The transmission technique that must be used to transmit multimedia content is then chosen either by the multimedia content provider; or by the user, when he possesses sufficient knowledge to do so; or as a result of a rigid association between the content type and the receiving line. However, in all cases, the transmission technique that is chosen to meet a request is not transparent for the requesting user, nor can it be dissociated from the perception of the service that is provided to meet his request.

The purpose of the invention is therefore to improve the situation.

For this purpose, it discloses a device for managing the receipt of multimedia content originating from at least two multimedia content transmission infrastructures implementing different transmission techniques, by at least one communication terminal capable of connecting to at least both of said infrastructures, said device for receiving multimedia content comprising management means configured, when one of said infrastructures wishes to transmit multimedia content to set communication terminal, to dynamically determine, in consultation with said terminal and said infrastructures to which said terminal is connected, depending on the type of said communication terminal and the technical and/or commercial parameter(s) chosen, the best transmission technique to use to transmit said multimedia content to it, then to request that said communication terminal configure its reception means so that it can receive said multimedia content to be transmitted via the infrastructure that implements said best transmission technique, characterized in that said technical parameters are chosen from a group comprising at least the bandwidth available at a given moment; the transmission frequencies available at a given moment; the type of multimedia content to be transmitted; the quality of service available at a given moment; the transmission time of the multimedia content to be transmitted; the size of the multimedia content to be transmitted; the number of terminals that must receive the multimedia content to be transmitted, at about the same time; and the existence of a peer terminal which is in the vicinity of said communication terminal that is to receive the multimedia content to be transmitted and which has order received said content to be transmitted;
the commercial parameters may, for example, be chosen from among (at a minimum) the costs of transmitting the multimedia content to be transmitted, the minimum quality of service required, and the service's pricing models;
the transmission techniques may, for example, be chosen from among (at a minimum) streaming mode, service provider over-the-air relay mode, push-VoD mode, and P2P client-to-client relaying mode;
the type of multimedia content to be transmitted may, for example, be chosen from among a first type corresponding to transmission that is roughly simultaneous with the generation of the content, and a second type corresponding to transmission after the content has been stored;
   the second type may, for example, comprise a first subtype corresponding to content that must be made available on a short deadline and for numerous communication terminals, and a second subtype corresponding to content that may be requested at any time by a small number of communication terminals, but which is not part of regular programming;
   the management means may be tasked with selecting the streaming technique, when the multimedia content to be transmitted is of the second subtype;
   the management means may be tasked with selecting either the service provider over-the-air relay distribution technique, or the push-VoD technique, or the P2P client-to-client relaying technique, when the multimedia content to be transmitted is of the first subtype.
      the management means may be tasked i) with selecting the P2P client-to-client relaying transmission technique, when the multimedia content to be transmitted is of the first subtype, and when there is a peer terminal which is in the vicinity of the communication terminal (the intended recipient of the multimedia content to be transmitted) and which has already received said content to be transmitted, and when the uplink bandwidth associated with the P2P client-to-client relaying transmission technique is sufficiently high; and ii) with selecting the push-VoD transmission technique when the multimedia content to be transmitted is of the first subtype and when the uplink bandwidth associated with the P2P client-to-client relaying transmission technique is insufficiently high and/or when there is no peer terminal which is in the vicinity of the communication terminal (the intended recipient of the multimedia content to be transmitted) and which has already received said content to be transmitted;
   the management means may be tasked with selecting either the public over-the-air broadcast technique, or the service provider over-the-air relay technique, when the multimedia content to be transmitted is of the first type;
the management means may be tasked with selecting the streaming technique when no other technique may be used.

The invention also discloses a server equipped with a management device of the type introduced above.

The invention also discloses a communication terminal capable of connecting to at least two infrastructures implementing different transmission techniques, and comprising a management device of the type introduced above.

Other characteristics and benefits of the invention shall become apparent upon examining the detailed description below, and the attached drawing, in which the sole FIGURE schematically depicts a server equipped with an embodiment of the management device of the invention, and an embodiment of the communication terminal of the invention, connected to multimedia content transmission infrastructures.

The attached drawing may serve not only to complete the invention, but also to contribute to defining it, if need be.

The main purpose of the invention is to enable transparency for the user of the communication terminal in the choice of the transmission technique used to transmit multimedia content to him, in such a way as to dissociate said choice from the perception that he has of the service provided.

In what follows, for the purpose of a nonlimiting example, the communication terminals (T) are considered to be CPE devices (for “Customer Premises Equipment”), such as residential gateways. However, the invention is not limited to this type of communication terminal. In reality, it pertains to any type of fixed or mobile (or portable or cellular) communication device capable of receiving multimedia content from multiple (at least two) different multimedia content transmission infrastructures, and to exchange data using wires or waves with other communication terminals or network devices via at least one point-to-point (potentially radio) network. Consequently, it may also be a landline or mobile (or cellular) telephone; a desktop or laptop computer; a personal digital assistant (or PDA); a multimedia content receiver (for example a decoder, residential gateway, or an STB (Set-Top Box)) equipped with communication means, potentially by radio or satellite, capable, at a minimum, of receiving distributed data as well as, potentially, exchanging data in unicast mode.

Furthermore, in what follows, for the purposes of a nonlimiting example, the multimedia content broadcast to the terminals is assumed to be television or radio programs. However, the invention is not limited to this type of multimedia content. In reality, it pertains to any type of multimedia content, in particular videos, audio content, and applications that may be downloaded.

As is schematically depicted in the sole FIGURE, the implementation of the invention requires the presence of at least one device D dedicated to managing the receipt of multimedia content; at least one (communication) terminal T (here, a residential gateway); and at least two multimedia content transmission infrastructures TIi.

In what follows, for the purposes of a nonlimiting example, the multimedia content may be transmitted to (communication) terminals T by five infrastructures TIi (i=1 á 5) distributed throughout a first group GRD made up of two multimedia content distribution networks TI1 and TI2 and a second group GRC made up of three communication networks TI3 to TI5. However, the invention is not limited to these numbers (2 and 3) of distribution networks and communication networks. In reality, it pertains to any communication installation comprising at least two infrastructures, in particular those which comprise only distribution networks, to those which comprise only communication networks, and those which comprise at least one distribution network and at least one communication network.

Certain infrastructures TIi may have their own source(s) of multimedia content. This is frequently the case for distribution networks TI1 and TI2. Other infrastructures are supplied with multimedia content (all types) by “external” multimedia content servers ES. This is frequently the case for communication networks TI3 to TI5, as depicted in the sole FIGURE.

Each infrastructure TIi is tasked at least with distributing multimedia content to the terminals T, using a specific transmission technique.

For the purposes of a nonlimiting example, infrastructure TI1 is a distribution network tasked with transmitting multimedia content using at least one streaming mode, infrastructure TI2 is a distribution network tasks with transmitting multimedia content using at least one public over-the-air broadcast technique, infrastructure TI3 is a communication network tasked with transmitting multimedia content using at least one service provider over-the-air relay technique, infrastructure TI4 is a communication network tasked with transmitting multimedia content using at least one push-VoD technique, and infrastructure TI5 is a communication network tasked with transmitting multimedia content using at least one P2P client-to-client relaying technique.

It should be noted that some of these infrastructures TIi may enable broadband wired transmission (such as by ADSL lines or cable or optical fibers), and that others may enable over-the-air transmission (such as by a wireless local area network (WLAN, such as a WiMAX network) or by a cellular network (UMTS or GPRS/EDGE or CDMA 2000) or by a satellite network, or by a hybrid network).

The streaming distribution technique may be unicast or multicast.

The public over-the-air broadcast technique and/or the service provider over-the-air relay technique may use a satellite and/or terrestrial channel.

The push-VoD technique consists of transmitting multimedia content to terminals a certain amount of time before their respective programming dates. In order to be able to implement this technique, the terminals T must have a temporary local storage memory MC, such as a memory cache (as depicted).

The P2P client-to-client relaying technique involves requesting that a first terminal (which has recently received multimedia content) transmit said content to at least one second requesting terminal located in its vicinity. Naturally, any other multimedia content transmission technique known to a person skilled in the art may be used.

The invention proposes to include in the installation at least one device D intended to dynamically select, from among all transmission techniques implemented by the TIi infrastructures to which at least one terminal T (the recipient of multimedia content) is connected, the one which is best suited for transmitting said multimedia content to said terminal T at the time when the decision to transmit it was made.

In the nonlimiting example depicted, the management device D is installed in a management server MS, which is connected to the groups GRD and GRC. It is therefore tasked with managing the receipt of multimedia content by multiple (if not all) terminals T of the invention. However, a variant may be imagined in which each terminal T of the invention is equipped with its own management device D. In such a case, said device only manages the receipt of multimedia content for its own terminal T.

A management device D of the invention comprises a management module MM tasked with intervening each time one of the infrastructures TIi wishes to transmit multimedia content to at least one terminal T or receive multimedia content which may be transmitted to it.

This intervention is first and foremost intended to dynamically select, in consultation with said receiving terminal and infrastructures TIi to which said terminal T is connected (here TI1 to TI5), depending on the type of terminal T and the technical and/or commercial parameters chosen, which transmission technique is best suited for transmitting said multimedia content to it. It should be understood that this selection requires exchanging messages both between the device D and the receiving terminal T, and between the device D and infrastructures TIi to which the terminal T is connected (here TI1 to TI5), because said infrastructures TI1 and said terminal T both have information necessary for making this selection.

Schematically, this information is intended to manufacture at least one part of the control plan, which will inform a terminal T of what it must do. This information may include the storage resources that the terminal T has at a given moment; the (dynamic) connectivity status of the terminal T at a given moment (such as the traffic on its ADSL line (or its cable) or status of access to TDT (“Terrestrial Digital Television”); information on content providers' services (such as ESG (“Electronic Service Guide”) programs); the definitions of the programs which the user of the terminal T wishes to access; predicted Push-VoD transfers; and the availabilities of the infrastructure TI1 (present status) at a given moment.

Once the selection has been made, the management module MM is tasked with requesting that the receiving terminal T configure its sending/receiving means SRM so as to be able to receive the multimedia content intended for it over the TIi infrastructure that implements the best transmission technique (the best-suited one).

Here, the phrase “configure its sending/receiving means SRM” refers to the act of using the antenna and processing module PMi which are suited for the best transmission technique that has been selected (such as wired transmission by cable or ADSL, or over-the-air transmission (such as by a wireless local area network (potentially WiMAX) or by a satellite or terrestrial distribution network)).

It should be noted that the multimedia content to be transmitted may be of two different types, and may therefore have two different origins. It may therefore be multimedia content that must be transmitted as it is generated (which is better known as “live content” and mainly pertains to information transmitted live and live shows). Its type is hereafter known as the “first type”. It may also be multimedia content that must be transmitted after having first been generated and stored (archived) in storage means (which is better known as “canned content” and pertains to most content broadcast (other than that broadcast live) and to on-demand movies or audio content). Its type is hereafter known as the “second type”.

Numerous technical parameters may be used by the management module MM to make a selection. The technical parameters that may be used notably include the bandwidth that is available at a given moment for each transmission technique; the transmission frequencies that are available at a given moment for each transmission technique; the type of multimedia content to be transmitted, the quality of service available at a given moment for each transmission technique; the transmission time of the multimedia content to be transmitted; the size of the multimedia content to be transmitted; the number of terminals T that must receive the multimedia content to be transmitted at roughly the same time; and the existence at a given moment of a peer terminal in the vicinity of said communication terminal T (that is to receive the multimedia content to be transmitted), and which has already received said content to be transmitted;

Generally speaking, any technical parameter of a dynamic nature, meaning that it can change over time, may be used.

Likewise, multiple commercial parameters may be used by the management module MM to make a selection. The commercial parameters that may be used may, in particular, include the cost of transmitting the multimedia content to be transmitted, the minimum quality of service required for transmitting the multimedia content, and the service's pricing models.

It should be understood that the management module MM is preconfigured in such a way as to make selections by taking into account both the type of requesting terminal T, and therefore its technical characteristics and the subscription held by its user with an operator; and one or more technical parameters and/or one or more commercial parameters. This preconfiguration is preferably adaptable.

We will now give a few example preconfigurations for the management module MM. In all of these examples, one of the technical parameters taken into account in the selection is a type of multimedia content to be transmitted.

In such a case, is advantageous to break the second type of multimedia content down into first and second subtypes. The first subtype may correspond to multimedia content that must be made available on a short deadline and for numerous terminals T (for example, more than 100). For example, this is the case for weekend television programs, or movies that are programmed for the coming month as part of a “movies on demand” feature.

The second subtype may correspond to multimedia content which may be requested at any time, but by a small number of terminals T (for example, fewer than 10), and which are not part of regular programming. For example, this is the case for old television programs or films which are rarely requested or rarely scheduled.

With such a breakdown, the management module MM may be pre-configured in such a way as to give priority to selecting the streaming broadcast technique when the multimedia content to be transmitted is of the second subtype. It is preferable to use streaming for this type of content, because it is not available in broadcast mode and cannot be transmitted in push-VoD mode.

On the other hand, when the multimedia content to be transmitted is of the first subtype, the management module MM may be preconfigured in such a way as to select either the service provider over-the-air relay technique or the push-VoD technique, or the P2P client-to-client relaying technique, or streaming. Selecting from among the four above-mentioned techniques may be done as indicated below.

For example, the management module MM may be preconfigured in such a way as to select the P2P client-to-client relaying transmission technique when, firstly, the multimedia content to be transmitted as of the first subtype; and secondly, there is a first peer terminal in the vicinity of the second terminal T (the intended recipient of the multimedia content to be transmitted) which has already received the multimedia content to be transmitted; and thirdly, the uplink bandwidth (of the first terminal to a communication network TIi) which is associated with the P2P technique is sufficiently high. Furthermore, the management module MM may be preconfigured in such a way as to select the push-VoD technique when, firstly, the multimedia content can be transmitted is of the first subtype; and secondly, the uplink bandwidth which is associated with the P2P technique is insufficiently high and/or there is no first peer terminal in the vicinity of the second terminal T (that is to receive the multimedia content to be transmitted) which has already received the multimedia content to be transmitted. As a reminder, this push-VoD technique may only be used if the terminal T receiving the multimedia content has a dedicated memory cache (or equivalent) MC.

If none of the two above-mentioned situations can be met, such as because at least one other technical parameter and/or at least one commercial parameter is taken into account, then the management module MM may, for example, be preconfigured so as to select the service provider over-the-air relay technique.

Finally, if the latter situation cannot be met, such as because at least one other technical parameter and/or at least one commercial parameter is taken into account, then the management module MM may, for example, be preconfigured so as to select the streaming technique by default.

When the multimedia content to be transmitted as of the first type, the management module MM may, for example, be preconfigured so as to select either the public over-the-air broadcast technique, or the service provider over-the-air relay technique, or the streaming technique. Selecting from among the three above-mentioned techniques may be done as indicated below.

For example, the management module MM may be preconfigured so as to give priority to selecting the public over-the-air broadcast technique. If this is not possible, such as because at least one other technical parameter and/or at least one commercial parameter is taken into account, then the management module MM may, for example, be preconfigured so as to select the service provider over-the-air relay technique. Finally, if the latter situation cannot be met, such as because at least one other technical parameter and/or at least one commercial parameter is taken into account, then the management module MM may, for example, be preconfigured so as to select the streaming technique by default.

Naturally, other example preconfigurations may be envisioned based on the specific parameters that must be taken into account for the selection.

As indicated above, each terminal T comprises a sending/receiving module SRM past, in particular, with receiving data that defines the multimedia content transmitted by the various infrastructures TIi. This sending/receiving module SRM therefore comprises antennas which are suitable for receiving data transmitted using the various transmission techniques implemented by the infrastructures TIi. These antennas are coupled to processing modules PMi tasked with processing the multimedia content received depending on their transmission technique.

In the nonlimiting example depicted, the terminal T comprises five processing modules PM1 to PM5 (i=1 to 5) that respectively correspond to the five transmission techniques implemented by the five infrastructures TI1 to TI5. However, this is not mandatory. The invention pertains to all communication terminals T, so long as they comprise at least two processing modules PMi.

When the terminal T receives from the device D a message requesting that it select one of the antennas in its sending/receiving module SRM, it configures said module so that the antenna can receive the data defining the multimedia content that will be transmitted to it by the selected infrastructure TIi selected for that purpose. When this data is received, the selected antenna sends it to the processing module PMi involved. This processing module PMi is then tasked with partially or fully reconstructing the multimedia content that is defined by the data provided by the selected antenna of the sending/receiving module SRM.

As some of multimedia content (such as that transmitted with the streaming technique, the public over-the-air broadcast technique, or the P2P technique) must be used in real time, the processing modules PM1, PM2, and PM5 (which are tasked with processing the data that define them) may communicate them to a collection module CO. The collection module CO may be tasked with transmitting the collected multimedia content to at least one device STn equipped with a device for reading multimedia content CR.

In the nonlimiting example depicted, the collection module CO is coupled to two devices ST1 and ST2 (n=1 or 2), such as decoders or Set Top Boxes (or STBs). However, the variable n may be given any value greater than or equal to one (1).

It should be noted that this terminal T may comprise the multimedia content reading device CR. This may, in particular, be the case if the terminal is a cellular phone, a PDA, or a communicating digital television set.

As the multimedia content transmitted with the service provider over-the-air relay technique must be transmitted either immediately or at a later time (depending on their type (or subtype)), the processing module PM3 (which is tasked with processing the data that define them) communicates them either directly to the collection module CO, or to the memory cache MC (so that they may later be communicated to the collection module CO), depending on their type.

As the multimedia content transmitted with the push-VoD technique must be transmitted at a later time, the processing module PM4 (which is tasked with processing the data that define them) communicates them to the memory cache MC so that they may later be communicated to the collection module CO.

It should be noted, as is depicted in a nonlimiting example in the sole FIGURE, that the terminal may potentially comprise a digital rights management (or DRM) module RM intended to limit the number of times that a given piece of multimedia content may be read by a reading device CR to which it is coupled. Such a digital rights management module RM may be placed between one of the inputs of the collection module CO and the output of the memory cache MC and one of the outputs of the processing module PM5.

The management device D of the invention, and in particular its management module MM, may be embodied in the form of electronic circuits, software (or computing) modules, or a combination of circuits and software.

The processing modules PMi of the terminal T, as well as the memory cache MC, if any, may be embodied in the form of electronic circuits, software (or computing) modules, or a combination of circuits and software.

The invention is not limited to the embodiments of the management device, the multimedia content server, and the communication terminal described above, which are given only as an example; rather, it encompasses all variants that a person skilled in the art may envision within the framework of the claims below.

1. A device (D) for managing the receipt of multimedia content, originating from at least two multimedia content transmission infrastructures (TIi) implementing different transmission techniques, by at least one communication terminal (T) capable of connecting to at least the two said infrastructures (TIi), said multimedia content receipt management device comprising management means (MM) configured, when one of said infrastructures (TIi) wishes to transmit multimedia content to said communication terminal (T), to dynamically select, upon consulting with said terminal and said infrastructures to which said terminal is connected and depending on the type of said communication terminal (T) and on chosen technical and/or commercial parameter(s), the best transition technique to use in order to transmit to it said multimedia content, then to request that said communication terminal (T) configure its receiving means (SRM) so that it may receive said multimedia content to be transmitted via the infrastructure (TIi) which implements said best transmission technique, characterized in that said technical parameters are chosen from a group that comprises at least the bandwidth that is available at a given moment, the transmission frequencies available at a given moment, the type of multimedia content to be transmitted, the quality of service available at a given moment, the transmission time of the multimedia content to be transmitted, the size of the multimedia content to be transmitted, the number of terminals that must receive the multimedia content to be transmitted at roughly the same time, and the existence of a peer terminal in the vicinity of said communication terminal (the intended recipient of the multimedia content to be transmitted) that has already received said multimedia content to be transmitted.

2. A device according to claim 1, characterized in that said commercial parameters are chosen from a group that comprises at least the cost for transmitting the multimedia content to be transmitted, the minimum quality of service required, and the service's pricing models.

3. A device according to claim 1, characterized in that the type of multimedia content to be transmitted is selected from either a first type corresponding to transmission that is roughly simultaneous to the generation of said content, and the second type corresponding to transmission occurring after said content has been stored.

4. A device according to claim 3, characterized in that said second type comprises a first subtype corresponded to content that must be made available on a short deadline and for numerous communication terminals (T), and a second subtype corresponding to content that may be requested at any time by a small number of communication terminals (T), but which is not part of regular programming.

5. A device according to claim 1, characterized that said transmission techniques are selected from a group comprising at least the streaming, public over-the-air broadcast, service provider over-the-air relay, push-VoD, and P2P client-to-client relaying techniques.

6. A device according to claim 4, characterized that said transmission techniques are selected from a group comprising at least the streaming, public over-the-air broadcast, service provider over-the-air relay, push-VoD, and P2P client-to-client relaying techniques and further characterized in that said management means are configured to select the streaming technique when the multimedia content to be transmitted is of the second subtype.

7. A device according to claim 6, characterized that said transmission techniques are selected from a group comprising at least the streaming, public over-the-air broadcast, service provider over-the-air relay push-VoD, and P2P client-to-client relaying techniques, and further characterized in that said management means (MM) are configured to select from among the service provider over-the-air relay, push-VoD, and P2P client-to-client relaying techniques when the multimedia content to be transmitted is of the first subtype.

8. A device according to claim 7, characterized in that said management means (MM) are configured i) to select the P2P client-to-client relaying technique when the multimedia content to be transmitted is of the first subtype and when there is a peer terminal in the vicinity of said communication terminal (T) (the intended recipient of the multimedia content to be transmitted) that has already received said multimedia content to be transmitted, and when the uplink bandwidth associated with the P2P client-to-client relaying transmission technique is sufficiently high, and ii) to select the push-VoD transmission technique when the multimedia content to be transmitted is of the first subtype when the uplink bandwidth associated with the 2P client-to-client relaying transmission technique is insufficiently high and/or there is no peer terminal in the vicinity of said communication terminal (T) (the intended recipient of the multimedia content to be transmitted) that has already received said multimedia content to be transmitted.

9. A device according to claim 3, characterized in that said management means (MM) are configured to select either the public over-the-air broadcast technique or the service provider over-the-air relay technique when the multimedia content to be transmitted is of the first type.

10. A device according to claim 5, characterized in that said management means (MM) are configured to select the streaming technique when no other techniques may be used.

11. A server (MS), characterized in that it comprises a management device (D) according to claim 1.

12. A communication terminal (T) capable of connecting to at least two multimedia content transmission infrastructures (TIi) implementing different transmission techniques, characterized in that it comprises a management device (D) according to claim 1.
